(19) United States
(12) Patent Application Publication
(10) Pub. No.: US 2012/0224137 A1
(43) Pub. Date: Sep. 6, 2012

(54) Eyeglasses Frame with Dual Hooks and a Slingshot

(75) Inventor: DI SHU LI, Shenzhen (CN)

(73) Assignee: Eagle International (Industrial) Limited, Hong Kong (CN)

(21) Appl. No.: 13/038,352

(22) Filed: Mar. 1, 2011

(51) Int. Cl. G02C 5/16

(52) U.S. Cl. 351/121

(57) ABSTRACT

An eyeglasses frame with dual hooks and a slingshot is provided, comprises a frame, legs and elastic connecting devices which connect the frame with the legs, wherein the elastic connecting device comprises a first element (1) and a second element (2) superimposed up and down, the first element (1) is arranged with a trough rim (5) at one end while the second element (2) is arranged with an opening (6) at one end, and between the first element (1) and the second element (2) a slingshot (3) is arranged, which comprises two layers up and down connected with each other at one end, and each of the two layers has a through hole (7); a hook element (4) is cap-shaped at one end and is hook-shaped at the other end, and its hook-shaped end passes through the opening (6) of the second element (2), the through holes (7) of the slingshot (3) and hitches into the trough rim (5) of the first element (1). The eyeglasses frame of the present invention is simple and beautiful, and is comfortable, thus is suitable for wearing in everyday life.

### FIELD OF THE INVENTION

The present invention relates generally to eyeglasses frame, and more specifically, to an eyeglasses frame with dual hooks and a slingshot.

### BACKGROUND OF THE INVENTION

Eyeglasses are an indispensable tool in people's living and work, which is used to correct visual acuity and protect eyes. As development of modern technologies and improvement of living standard, people request a higher standard to the eyeglasses, especially to the comfort of eyeglasses. At present, most legs of general eyeglasses are pivoted with corner components via a screw, but such a joint structure of the eyeglasses doesn't have elasticity when opening out it or folding it. Some other designs include a tubular connecting element, which is arranged with a spring therein and connected with the corner components via a screw. However the structure of such eyeglasses is complex and the manufacturing process is costly.

### SUMMARY OF THE INVENTION

The present invention intended to provide an eyeglasses frame with dual hooks and a slingshot, which has elasticity when being open out or folded and simple manufacturing process, and is easy to install.

In an aspect of the invention, an eyeglasses frame with dual hooks and a slingshot is provided, comprising a frame, legs and elastic connecting devices which connect the frame with the legs, wherein the elastic connecting device comprises a first element and a second element superimposed up and down, the first element is arranged with a trough rim at one end while the second element is arranged with an opening at one end, and between the first element and the second element a slingshot is arranged, which comprises two layers up and down connected with each other at one end, and each of the two layers has a through hole; a hook element is cap-shaped at one end and is hook-shaped at the other end, and its hook-shaped end passes through the opening of the second element, the through hole of the slingshot and hitches into the trough rim of the first element.

Advantageously, said slingshot is formed by elastic steel sheet.

Advantageously, the hook-shaped end of the hook element has a curved outer edge.

The eyeglasses frame of the present invention has simple structure, and is easy to be installed and assembled. The eyeglasses frame has elasticity when being open out or folded to facilitate convenience of use. The eyeglasses frame has simple and beautiful profile, and is comfortable when wearing it, thus people's requirements for comfort and beauty are satisfied.

### BRIEF DESCRIPTION OF THE DRAWINGS

FIG. 1 is a front view of the assembly structure in accordance with an embodiment of the present invention.

FIG. 2 is a top view of the assembly structure in accordance with an embodiment of the present invention.

FIG. 3 is a front view of the second element 2 in accordance with an embodiment of the present invention.

FIG. 4 is a front view of the slingshot 3 in accordance with an embodiment of the present invention.

FIG. 5 is a top view of the slingshot 3 in accordance with an embodiment of the present invention.

FIG. 6 is a front view of the hook element 4 in accordance with an embodiment of the present invention.

FIG. 7 is a front view of the first element 1 in accordance with an embodiment of the present invention.

FIG. 8 is a top view of the first element 1 in accordance with an embodiment of the present invention.

### DETAILED DESCRIPTION OF THE INVENTION

These and other aspects of the present invention will become apparent from the following description of the preferred embodiment taken in conjunction with the following drawings. It should be understood that the embodiments described here are only for the purposes of illustration and description and is not intended to be exhaustive or to limit the invention to the precise forms disclosed.

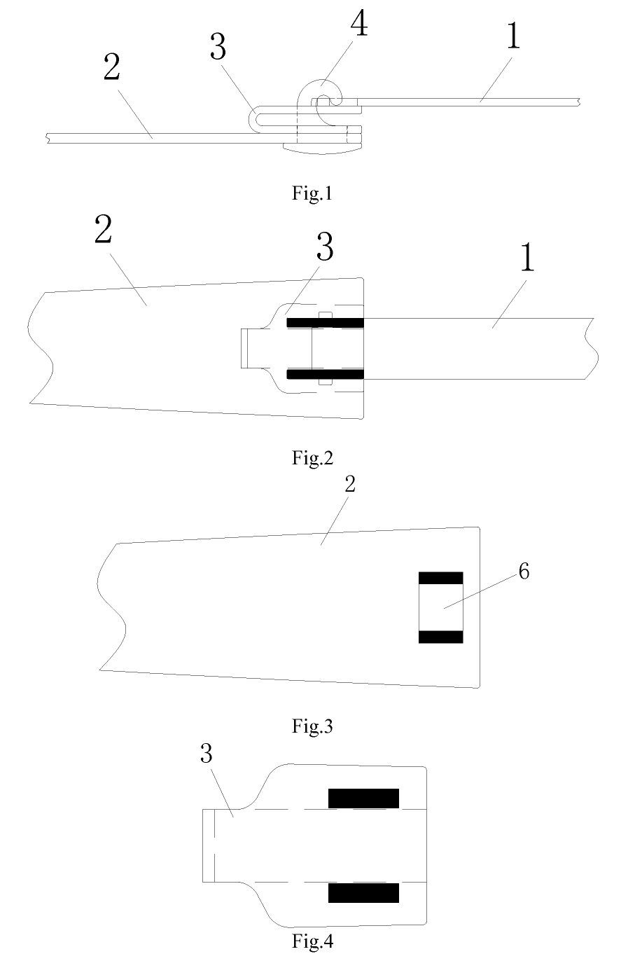

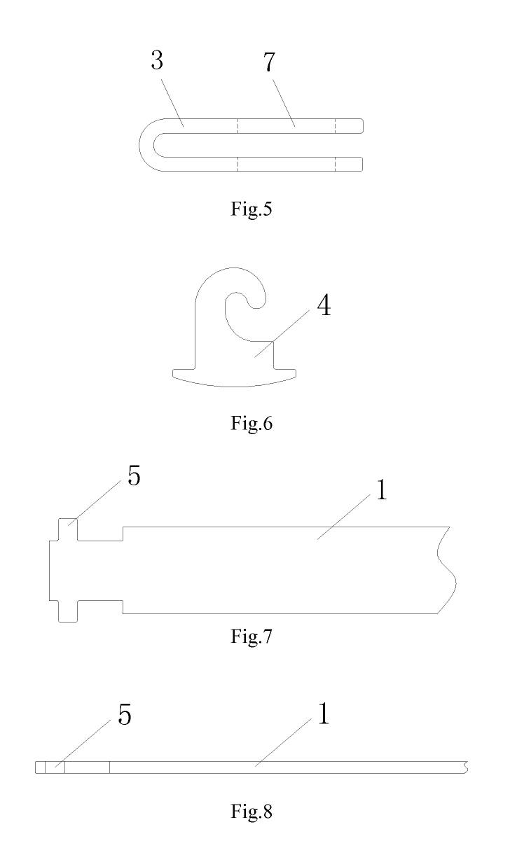

FIG. 1 and FIG. 2 show an assembly structure of an embodiment of the present invention. The eyeglasses frame of the present invention comprises a frame, legs and elastic connecting devices which connect the frame with the legs, wherein the elastic connecting device comprises a first element 1 and a second element 2 superimposed up and down, the first element 1 connects to the legs while the second element 2 connects to the frame to form a whole eyeglasses. A slingshot 3 is arranged between the first element 1 and the second element 2. The slingshot 3 is formed through pressing of the elastic steel sheet, which includes two layers up and down connected with each other at one ends to form a U-shaped structure, and each of the two layers has a through hole 7, as shown in FIG. 4 and FIG. 5. The first element 1 is arranged with a trough rim 5 at its one end, as shown in FIG. 7 and FIG. 8, while the second element 2 is arranged with an opening 6 at its one end, as shown in FIG. 3. As shown in FIG. 6, one end of the hook element 4 is cap-shaped, while the other end of the hook element 4 is hook-shaped, and the hook-shaped end has a curved outer edge. The hook-shaped end passes through the opening 6 of the second element 2, the through hole 7 of the slingshot 3 and then hitches into the trough rim 5 of the first element 1, such that the first element 1 is elastically connected with the second element 2.

What is claimed is:

1. An eyeglasses frame with dual hooks and a slingshot, comprising a frame, legs and elastic connecting devices which connect the frame with the legs, wherein the elastic connecting device comprises a first element (1) and a second element (2) superimposed up and down, the first element (1) is arranged with a trough rim (5) at one end while the second element (2) is arranged with an opening (6) at one end, and between the first element (1) and the second element (2) a slingshot (3) is arranged, which comprises two layers up and down connected with each other at one end, and each of the two layers has a through hole (7); a hook element (4) is cap-shaped at one end and is hook-shaped at the other end, and its hook-shaped end passes through the opening (6) of the second element (2), the through holes (7) of the slingshot (3) and hitches into the trough rim (5) of the first element (1).

2. The eyeglasses frame according to claim 1, wherein said slingshot (3) is formed by elastic steel sheet.

3. The eyeglasses frame according to claim 1, wherein the hook-shaped end of the hook element (4) has a curved outer edge.
